(19) United States
(12) Patent Application Publication
(10) Pub. No.: US 2008/0285006 A1
(43) Pub. Date: Nov. 20, 2008

(54) METHOD OF MANFACTURING SEMICONDUCTOR DEVICE

(75) Inventor: Yoshihisa MATSUBARA, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, KANAGAWA (JP)

(21) Appl. No.: 11/853,038

(22) Filed: Sep. 11, 2007

(30) Foreign Application Priority Data
Sep. 12, 2006 (JP) 2006-247286

(51) Int. Cl. G03B 27/42

(52) U.S. Cl. 355/77

(57) ABSTRACT

To attain a method of manufacturing a semiconductor device using an exposure system capable of obtaining preferable resolution while an adverse effect caused by a reduction in depth-of-focus margin is prevented, there is provided a method of manufacturing a semiconductor device comprising exposing a first portion of a wafer with a first lens aperture, and exposing a second portion of the wafer with a second lens aperture.

### BACKGROUND OF THE INVENTION

1. Field of the Invention

The present invention relates to a method of manufacturing a semiconductor device, and more particularly, to a method of manufacturing a semiconductor device which is applied to a lithography apparatus having high sensitivity to an absolute step on a substrate surface.

2. Description of the Related Art

In a semiconductor manufacturing process, a wafer to which a photoresist is applied is set in an exposure apparatus which is called a stepper and a mask pattern is transferred to the wafer. In order to form a more minute pattern, various resolution enhancement technologies are employed and typical examples thereof include a modified illumination method using an improved illumination system and a phase shift method using an improved mask (reticle). With a reduction in feature size of a semiconductor device, various ideas have been proposed to use existing exposure apparatus. For example, the improvement of the photoresist, the modification of the illumination method, and the use of the phase shift mask have been made.

The phase shift mask is used to modify a mask manufacturing method (and a mask structure) for improving exposure resolution. To be specific, a phase shifter for shifting a phase of light is provided on a photomask and a phase difference between light passing through the pattern with phase shifter and light not passing through the pattern is used to improve the resolution. In addition, there is a proximity effect correction method using a pattern part of which is locally expanded or narrowed in advance for correction based on the assumption that the pattern projected to a wafer will be deformed by an optical proximity effect.

Efforts for improving the resolution by the above-mentioned exposure method have been made up to now. However, a difference in absolute hight of patterns on a wafer or the wafer itself often exists depend on position on the wafer (a central portion or an edge portion thereof) as a result of previous processes such as etching during CMP process, which greatly hinders the improvement of the resolution. That is, even when an etching rate is controlled, it is difficult to prevent the occurrence of an absolute step on a wafer. The step causes a depth-of-focus (DOF) margin difference between the central portion and the edge portion of the wafer. The resolution and the DOF margin have a trade-off relationship. Therefore, when a high-resolution exposure condition is set corresponding to the central portion of a wafer, the exposure condition exceeds DOF margin (limit on the edge portion of the wafer. In other words, when an exposure condition is set to retain the DOF margin in the entire wafer, it is difficult to obtain the high resolution.

FIG. 12 shows a cross section of a wafer and a wiring resistance. In FIG. 12, “A” indicates a non-defective product, “B” indicates a defective product (defective level is low), and “C” indicates a defective product (defective level is as high as unmeasurable level). An edge height with respect to the central portion of the wafer can be controlled by an etching rate. However, the height of the edge portion is determined by a curvature of the wafer and thus is difficult to control. In particular, for each wafer, it is difficult to make the hights equal between the edge portion whose etching rate is higher and the central portion.

A latest lithography apparatus has an advantage of improving the resolution but still a disadvantage of reducing the DOF margin. That is, although the improvement of the resolution is required for a lithography step in a semiconductor device manufacturing process, when lithography with high numerical aperture (NA) lens is employed, there is a problem that the depth of focus becomes shallower. In general, an image contrast is important in a case of a dense pattern. However, a light intensity is not obtained for an isolated wiring or the like, so there is a problem that the DOF margin reduces.

The flatness of wafer surface during a device manufacturing process is required and an increase in diameter of a lens becomes a difficult requirement on a high-NA lithography tool, so the aberration in the periphery of the lens becomes a big problem. With an increase in diameter of a wafer (for example, 300 mm in diameter), a field area increases simultaneously. In recent years, a field size increases up to approximately 25 mm. In order to manufacture a large-diameter lens, the spherical precision of the lens, the transmittance of the lens, and the like must be improved. For example, in order to improve the performance of the lens, it is necessary to prevent irregular light reflection in the lens which is called a flare and improve image quality reduced by fogging (irregular reflection) in the periphery of the lens. The reduction in image quality particularly causes a reduction in resolution in the periphery of the lens, so a DOF process window of an isolated via hole or an isolated wiring further narrows.

The correction with the precision equal to or higher than a micron level is required for a wafer stage (JP 2004-221323 A). Although planarization which is performed by CMP at the time of wiring formation and a wafer stage flatness precision of 100 nm level are required in order to form a minute wiring of a five-layer level as a multilayer wiring, there is a problem that the number of work steps is large. Because of such a problem, as shown in FIG. 13, there is a tendency that the dependence of a focus position on minimum patterning size within the surface of the wafer is shifted between the central portion and the edge portion.

A method of changing a focus position and the amount of irradiation between the peripheral portion and the central portion and performing exposure based on the case of the peripheral portion is proposed as a method for solving the problem (JP 2004-513528 A, FIG. 14). However, with a reduction in pattern size, the DOF margin reduces, so it is difficult to satisfy both the resolution and the uniformity. That is, when the amount of irradiation increases, minute patterning capability reduces. According to a method of shifting the focus depth, it is necessary to change a condition for the amount of focus variation on the peripheral portion for each wafer, so setting for each wafer is complicated.

According to JP 2004-513528 A, the amount of reprocessing caused by process non-uniformity is reduced to improve a yield in a semiconductor manufacturing process. However, the method described in JP 2004-513528 A is not intended to improve the uniformity of the same wafer. Therefore, enhancing both the resolution and the wafer uniformity has not been realized so far.

### SUMMARY

The present invention has been made in view of the above-mentioned circumstances. An object of the present invention is to obtain preferable resolution while an adverse effect caused by a reduction in depth-of-focus margin is prevented.

According to the present invention, there is provided a method of manufacturing a semiconductor device comprising: exposing a first portion of a wafer with a first lens aperture, and exposing a second portion of the wafer with a second lens aperture.

According to the present invention, the exposure is performed a plurality of times while two or more kinds of lens apertures are used. Therefore, the exposure can be concentrically performed on different regions of the wafer under different irradiation conditions. According to such exposure, resolution or a DOF margin can be adjusted according to a wafer region. As a result, a trade-off balance between the resolution and the DOF margin can be adjusted as appropriate and uniformity of the wafer can be improved.

To be specific, even in the case where a step is generated in a peripheral portion of the wafer during previous process step such as etching, when the trade-off balance is adjusted according to an irradiation region by the above-mentioned method, preferable uniformity of the wafer can be obtained. For example, when exposure is performed such that an emphasis is placed on the resolution in a central portion of the wafer, and high priority is placed on the DOF margin in the peripheral portion thereof, the preferable uniformity is obtained.

According to the present invention, while the preferable resolution is maintained, a high depth-of-focus margin can be obtained and uniformity with respect to lithography precision can be improved.

### BRIEF DESCRIPTION OF THE DRAWINGS

In the accompanying drawings:

FIGS. 1A to 1E are explanatory cross sectional views showing a two-layer wiring process flow in a first embodiment of the present invention;

FIGS. 2A to 2D are explanatory cross sectional views showing the two-layer wiring process flow in the first embodiment of the present invention;

FIGS. 3A to 3C are explanatory cross sectional views showing the two-layer wiring process flow in the first embodiment of the present invention;

FIG. 4 shows an exposure condition (wafer in-plane) in Example 1;

FIG. 5 is a graph showing a dependence of a DOF margin on minimum wiring size;

FIG. 6 is a graph showing a wiring resistance distribution of Example 1.

FIG. 7 shows a lithography condition of Example 2;

FIG. 8 shows a dependence of a CD size on minimum size in Example 2;

FIGS. 9A to 9E are explanatory cross sectional views showing a two-layer wiring process flow in a conventional technique;

FIGS. 10A to 10D are explanatory cross sectional views showing the two-layer wiring process flow in the conventional technique;

FIGS. 11A to 11C are explanatory cross sectional views showing the two-layer wiring process flow in the conventional technique;

FIG. 12 shows a cross section of a wafer and a wiring resistance pattern;

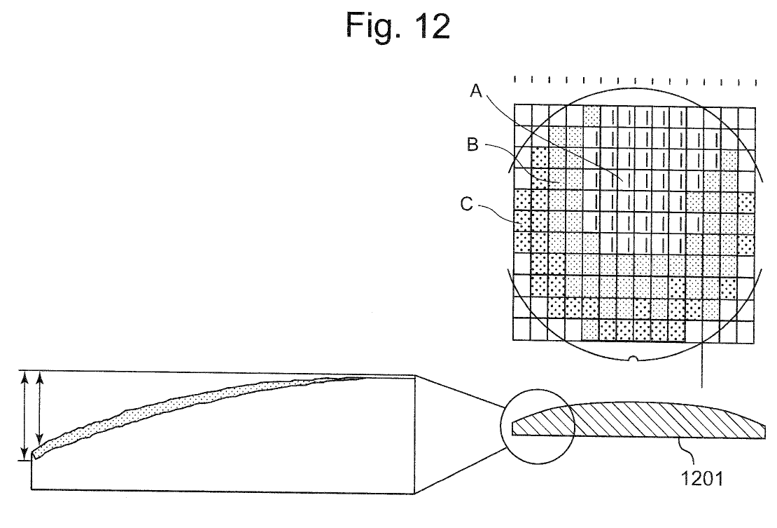

FIG. 13 is a graph showing a dependence of a DOF margin on wiring size (conventional technique); and

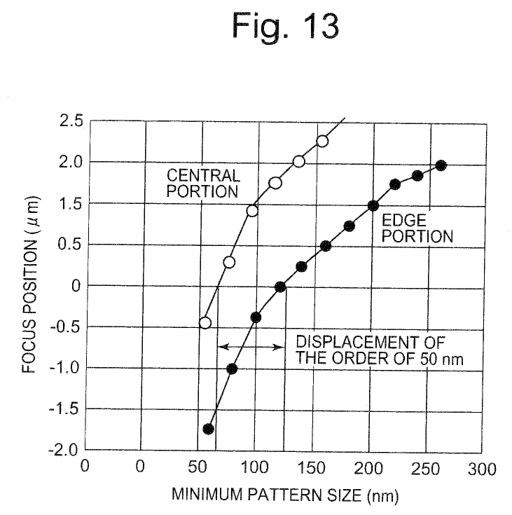

FIG. 14 shows an exposure condition (wafer in-plane) in a conventional method.

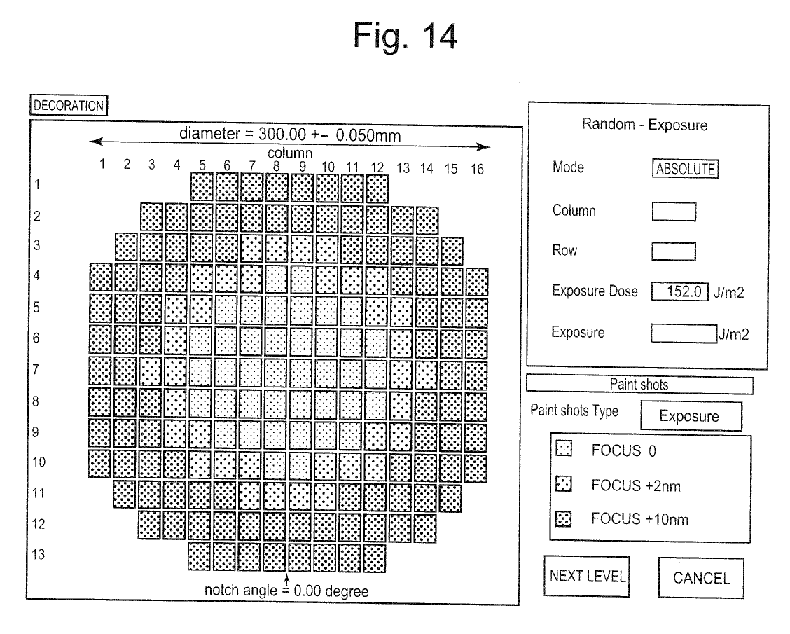

### DETAILED DESCRIPTION OF THE PREFERRED EMBODIMENTS

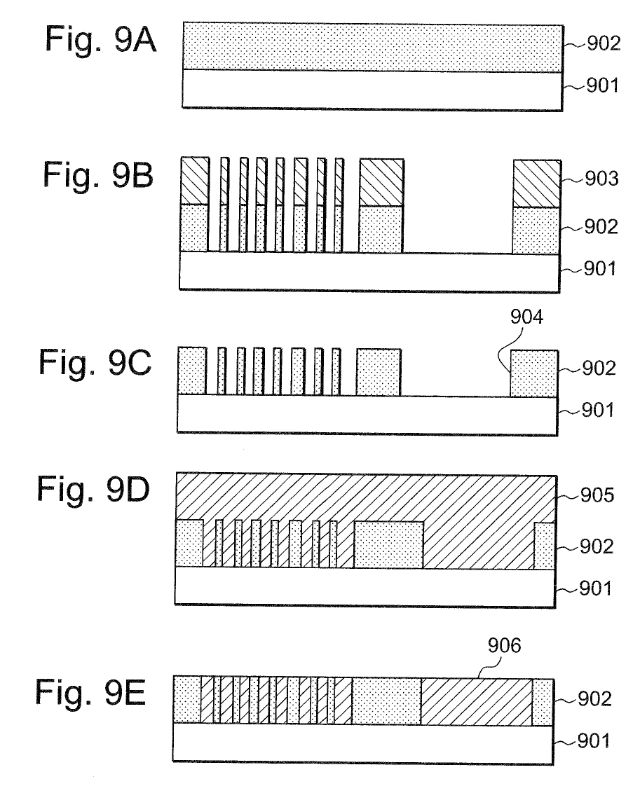

In order to easily understand the present invention, first, a general process for forming a two-layer wiring will be described. FIGS. 9A to 9E are cross sectional views showing a main process of a conventional pattern forming method.

A first interlayer insulating film 902, which is, for example, a silicon oxide film, is formed on a silicon substrate 901 which is a semiconductor substrate by a CVD method or the like (FIG. 9A). After that, a resist 903 is applied onto the first interlayer insulating film 902 and patterned by a photolithography method (FIG. 9B). Then, a resist pattern is transferred to the insulating film by a dry etching technique to form a wiring groove 904 in a desirable position (FIG. 9C).

A conductive film 905 made of, copper, aluminum, or the like is formed on the entire surface of the first interlayer insulating film 902 including the wiring groove 904 (FIG. 9D). Then, the surface of the first interlayer insulating film 902 is planarized by CMP (FIG. 9E). As a result, a first wiring 906 having a damascene wiring structure is formed in a desirable position of the first interlayer insulating film 902.

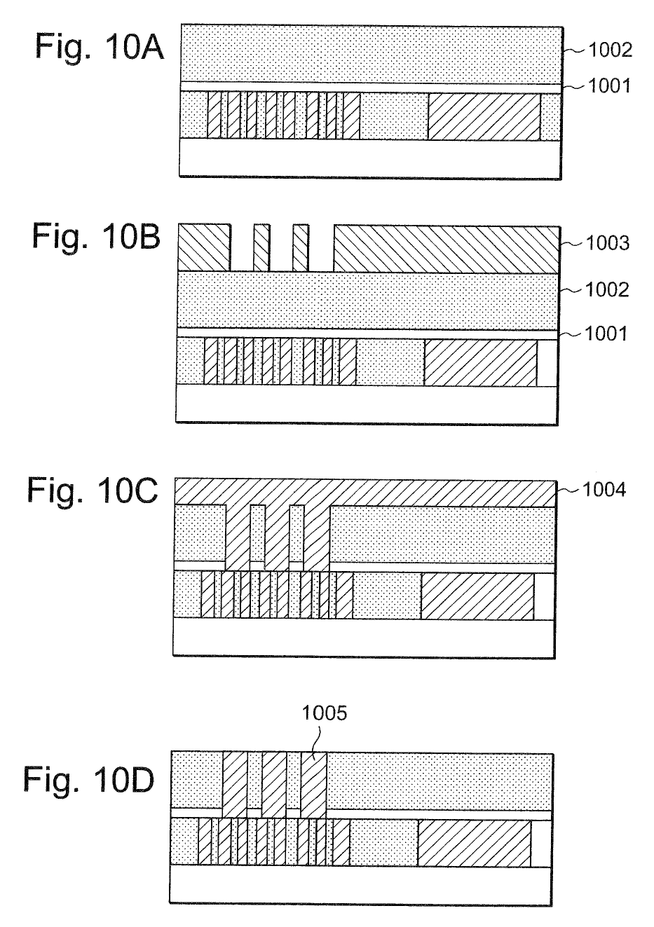

A diffusion barrier film 1001 made of SiC or the like is formed on the copper wiring. Subsequently, a second interlayer insulating film 1002 which is, for example, a silicon oxide film is formed on the diffusion barrier film 1001 (FIG. 10A). After that, a via hole formation resist (pattern) 1003 for lithography is formed on the second interlayer insulating film 1002 by patterning using a photolithography method (FIG. 10B).

Here, a method of changing the amount of irradiation between the central portion and the peripheral portion is proposed as a conventional technique. For example, the amount of irradiation to the central portion is set to 152 J/m2 and the amount of irradiation to the peripheral portion is set to 158 J/m2 (see JP 2004-513528 A).

The resist pattern is transferred to the insulating film by a dry etching technique to form a via hole pattern in a desirable position (FIG. 10B).

Next, a conductive film 1004 made of, copper, aluminum, or the like is formed on the entire surface of the second interlayer insulating film 1002 (FIG. 10C). Then, the surface of the second interlayer insulating film 1002 is planarized by CMP (FIG. 10D). As a result, via holes 1005 are formed in desirable positions of the second interlayer insulating film 1002 (FIG. 10D).

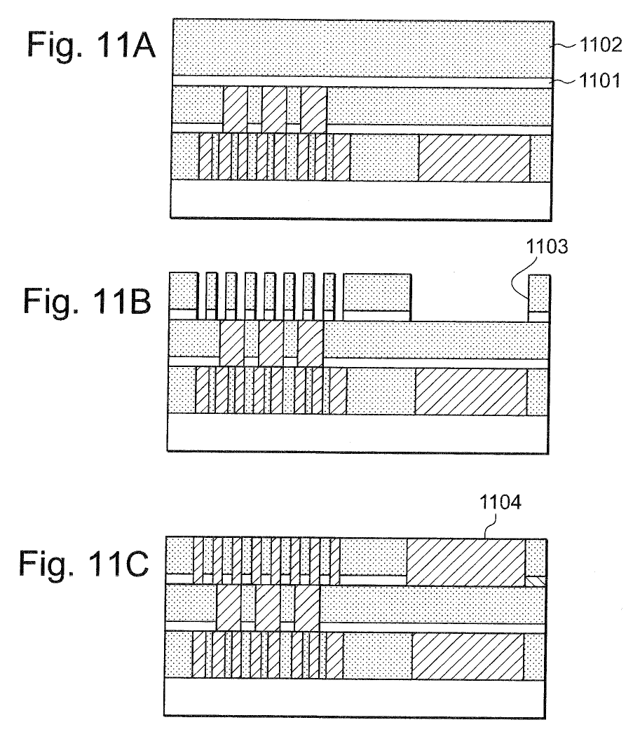

After the formation of the via holes 1005, a diffusion barrier film 1101 made of SiC or the like is formed on the copper wiring. Subsequently, a third interlayer insulating film 1102, which is, for example, a silicon oxide film, is formed on the diffusion barrier film 1101 (FIG. 11A). After that, a lithography resist pattern for second wiring formation is formed on the third interlayer insulating film 1102 by patterning using a photolithography method. Then, the resist pattern is transferred to the insulating film by a dry etching technique to form a wiring groove 1103 in a desirable position (FIG. 11B). Next, a conductive film made of, copper, aluminum, or the like is formed on the entire surface of the third interlayer insulating film 1102 including the wiring groove 1103. Then, the surface of the third interlayer insulating film 1102 is planarized by CMP. As a result, a first wiring 1104 having a damascene wiring structure is formed in a desirable position of the third interlayer insulating film 1102 (FIG. 11C).

The conventional pattern forming method is described. As described above, according to this method, it is difficult to obtain preferable resolution while an adverse effect caused by a reduction in depth-of-focus margin is prevented.

### First Embodiment

An embodiment of the present invention will be described with reference to the accompanying drawings. In each of the drawings, the same constituent elements are expressed by the same reference numerals and thus the descriptions are omitted as appropriate.

In this embodiment, in an exposure process for forming a wiring pattern including a wiring whose wiring width is equal to or smaller than 100 nm, exposure is performed a plurality of times while two or more kinds of exposure apertures are concentrically used. To be specific, the exposure process includes a first exposure step of exposing the central portion on the surface of the wafer and a second exposure step of exposing the peripheral portion around the central portion using an illumination system in which a different one of the exposure apertures from one of the exposure apertures used in the first exposure step is concentrically used. For example, dipole illumination method is used for the illumination system for the first exposure step and annular illumination is used for the illumination system for the second exposure step.

Hereinafter, a semiconductor device manufacturing process to which a pattern forming method according to this embodiment is applied will be described with reference to the accompanying drawings.

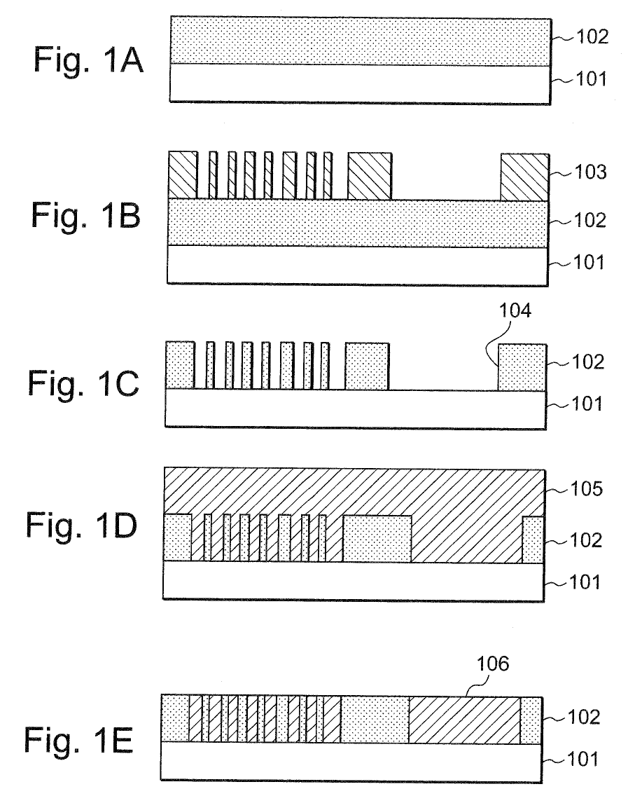

A first interlayer insulating film 102, which is, for example, a silicon oxide film is formed on a silicon substrate 101 by a CVD method or the like (FIG. 1A). After that, a lithography resist (pattern) 103 is formed on the first interlayer insulating film by patterning using a photolithography method (FIG. 1B).

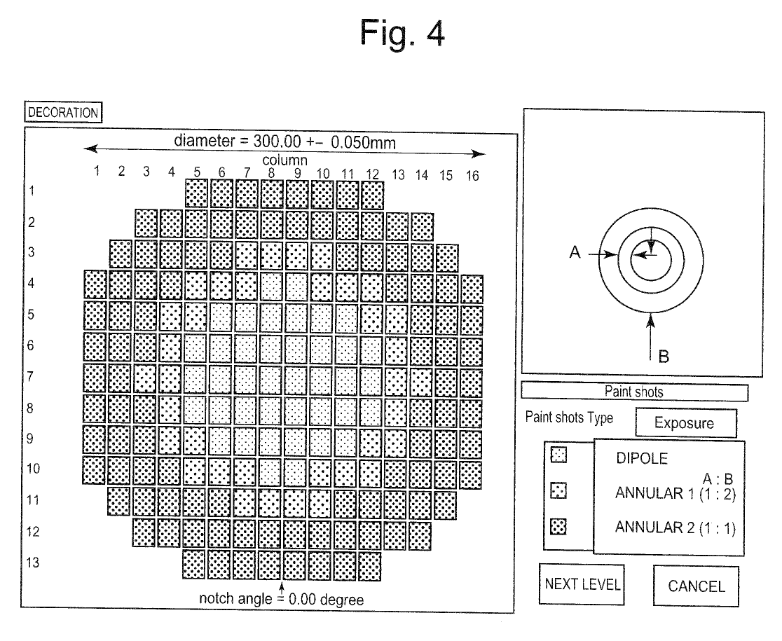

A wafer exposure condition at this stage is shown in FIG. 4. The central portion of a wafer is exposed by the dipole illumination of a first illumination system. The outside of the central portion is exposed by second and third exposure illumination systems using the annular illumination instead of the dipole illumination. In the second exposure illumination system, an annular ratio A:B is 1:2. In the third exposure illumination system, the annular ratio is increased to 1:1. According to such illumination systems, an exposure margin can be ensured. The same mask can be used for exposure in each of the first exposure step and the second exposure step.

Subsequently, the resist pattern is transferred to the insulating film by a dry etching technique to form a wiring groove 104 in a desirable position (FIG. 1C).

Next, a conductive film 105 made of, copper, aluminum, or the like is formed on the entire surface of the first interlayer insulating film 102 including the wiring groove 104 (FIG. 1D) Then, the surface of the first interlayer insulating film 102 is planarized by CMP (FIG. 1E). As a result, a first wiring 106 having a damascene wiring structure is formed in a desirable position of the first interlayer insulating film 102 (FIG. 1E).

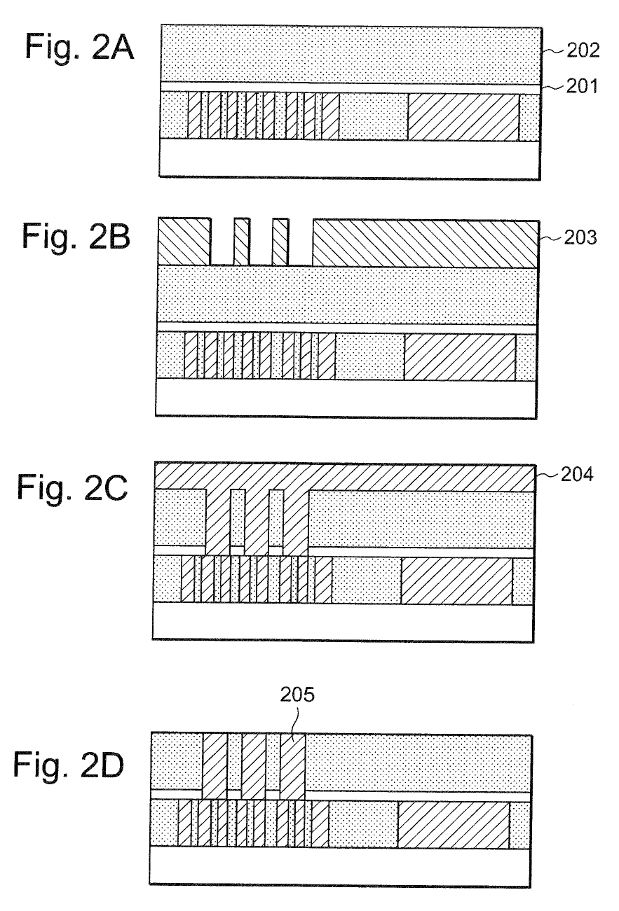

A diffusion barrier film 201 made of SiC or the like is formed on the copper wiring. Subsequently, a second interlayer insulating film 202, which is, for example, a silicon oxide film is formed on the diffusion barrier film 201 (FIG. 2A). After that, a via hole formation resist (pattern) 203 for lithography is formed on the second interlayer insulating film 202 by patterning using a photolithography method (FIG. 2B). Then, the resist pattern is transferred to the insulating film by a dry etching technique to form a via hole pattern in a desirable position.

Next, a conductive film 204 made of, copper, aluminum, or the like is formed on the entire surface of the second interlayer insulating film 202 (FIG. 2C). Then, the surface of the second interlayer insulating film 202 is planarized by CMP (FIG. 2D). As a result, via holes 205 are formed in desirable positions of the second interlayer insulating film 202 (FIG. 2D).

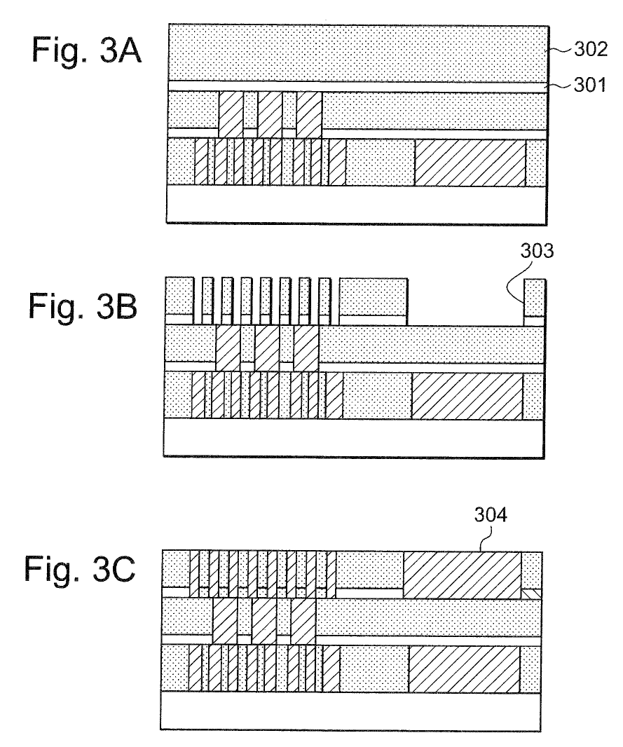

After the formation of the via holes, a diffusion barrier film 301 made of SiC or the like is formed on the copper wiring. Subsequently, a third interlayer insulating film 302 which is, for example, a silicon oxide film is formed on the diffusion barrier film 301 (FIG. 3A). After that, a lithography resist (pattern) for forming a second wiring is formed on the third interlayer insulating film by patterning (FIG. 3B). The resist pattern is transferred to the insulating film to form a wiring groove 303 (FIG. 3B). Next, a conductive film is formed on the entire surface of the third interlayer insulating film 302 including the wiring groove 303. Then, the surface of the third interlayer insulating film 302 is planarized. As a result, a second wiring 304 is formed in the third interlayer insulating film 302 (FIG. 3C). A wafer exposure system under a lithography exposure condition for the second wiring at this stage is identical to that in the case of FIG. 1B. That is, the exposure can be performed by the first exposure step of exposing the central portion on the surface of the wafer and the second exposure step of exposing the peripheral portion using an illumination system different from that in the first exposure step. For example, the dipole illumination is used for the illumination system for the first exposure step and the annular illumination is used for the illumination system for the second exposure step. An illumination system including second and third illumination systems may be used for the second exposure step.

The central portion of the wafer is exposed by the dipole illumination of the first illumination system. The outside of the central portion is exposed by the second and third wiring exposure illumination systems using the annular illumination instead of the dipole illumination. Therefore, the exposure margin can be ensured. The same mask can be used for exposure in each of the first exposure step and the second exposure step. In the second exposure illumination system, the annular ratio A:B is, for example, 1:2. In the third exposure illumination system, the annular ratio is increased to 1:1.

According to the method of this embodiment, the central portion and the peripheral portion are exposed using the same mask by the different illumination systems. Therefore, even when there is a DOF margin difference between the central portion of the wafer and the edge portion thereof, a high DOF margin can be obtained in the edge portion without a reduction in resolution of the central portion.

As described above, according to this embodiment, the large depth-of-focus margin can be obtained while preferable resolution is maintained and the uniformity on lithography precision can be improved.

### Second Embodiment

In this embodiment, a mask corresponding to the dipole condition in the first embodiment is used. The same layer of the semiconductor device is exposed using two or more masks having the same design. The masks having the same design are masks whose pattern shapes are the same but whose only sizes are different from each other. For example, exposure masks for the central portion and the peripheral portion are made different from each other. That is, the masks correspond to a plurality of masks having the same design in which a mask size of isolated lines (wirings) or isolated holes which are located at a certain distance is adjusted.

In the case of the first embodiment, only the lens apertures are adjusted. Therefore, when hole sizes are different from each other, the first embodiment cannot be applied to the case where a semiconductor device designed to have difference hole sizes is to be manufactured. Thus, when the present invention is applied to the case of different hole sizes or the case of different line (wiring) mask, it is desirable to perform exposure while, for example, the mask for the central portion is different from the mask for the peripheral portion.

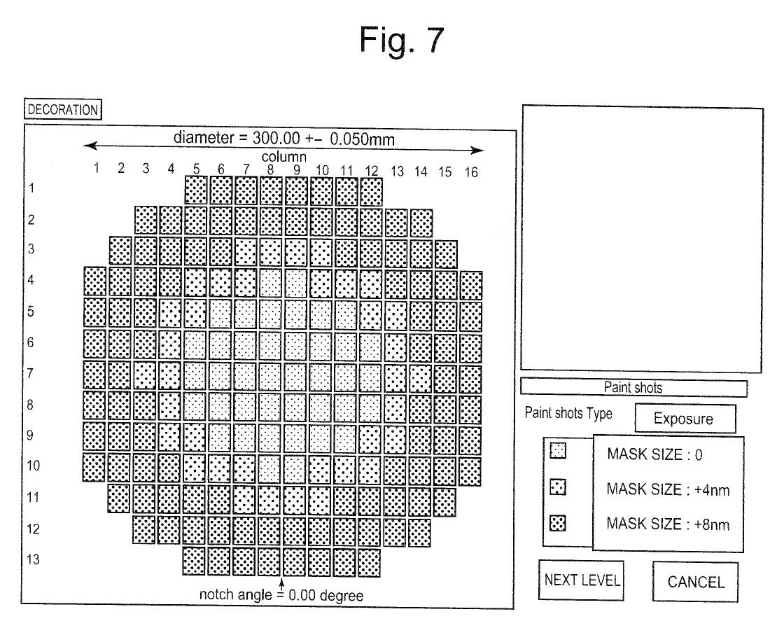

In this embodiment, as shown in FIG. 7, for example, a mask whose wiring mask width is +4 nm larger than a design value is used for the central portion. A mask whose wiring mask width is shifted by +8 nm can be used for the peripheral portion. For the simple explanation, the magnification of mask pattern against the corresponding pattern a wafer is omitted.

Exposure is concentrically performed two or more times on the surface of the wafer using a plurality of masks having the same design by a plurality of exposure systems. For example, in order to perform exposure two or more times, the dipole illumination is used for the first exposure system for the central portion on the surface of the wafer and the annular illumination is used for the second and third exposure systems for the peripheral portion.

As described above, different masks and illumination systems are used to expose the central portion and the peripheral portion, so an optimum process can be realized.

The embodiments of the present invention are described with reference to the drawings. The embodiments are examples of the present invention and thus various structures other than the above-mentioned structures can be employed.

For example, in the first embodiment, the exposure is performed by the first exposure step of exposing the central portion on the surface of the wafer and the second exposure step of exposing the peripheral portion using an illumination system different from that in the first exposure step. An illumination system including the second and third illumination systems or an illumination system including the second and third illumination systems and another illumination system may be used for the second exposure step. A third exposure step may be performed.

In the second embodiment, the exposure may be performed two or more times using the first illumination system for the central portion on the surface of the wafer and only the second illumination system for the peripheral portion thereon. Alternatively, the exposure may be performed two or more times using third or more illumination systems for the peripheral portion.

While the wiring is exemplified as a conductor pattern in the above-described embodiment, the conductor may be a gate electrode, silicide layer, or diffusion layer. That is, the present invention is applicable not only to the wiring, but also to the gate electrode, silicide layer, or diffusion layer.

### EXAMPLES

### Example 1

The exposure process was performed by the same method as that in the first embodiment. The wafer exposure condition at this stage is shown in FIG. 4. The central portion of a wafer is exposed by the dipole illumination in the first exposure step. While, the outside of the central portion was exposed, in the second and third wiring exposure steps, by the annular illumination system instead of the dipole illumination. Therefore, the exposure margin was ensured. In the second illumination, the annular ratio A:B was 1:2. In the third illumination, the annular ratio was increased to 1:1. The same mask was used for each of the exposure steps.

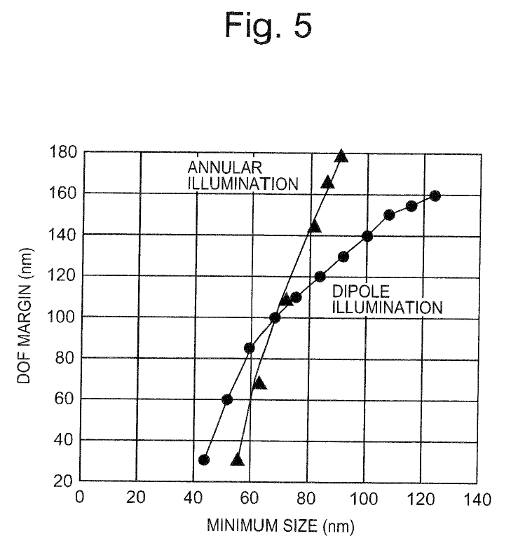

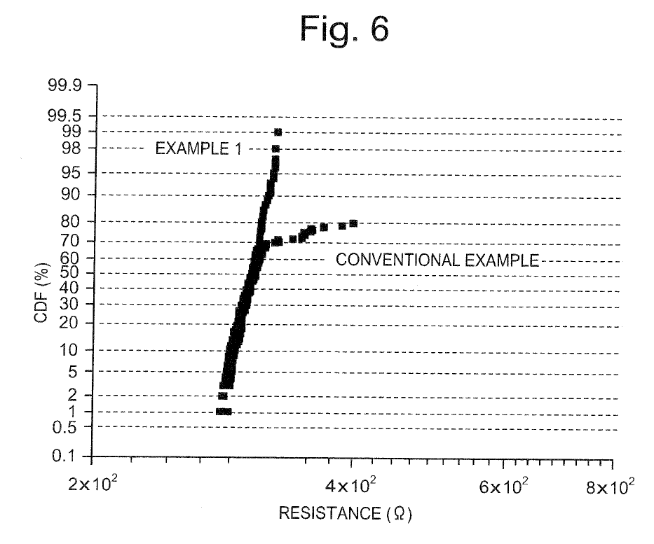

FIG. 5 is a graph showing the dependence of a DOF margin on minimum wiring size. When a first illumination region and a second illumination region on the central portion are overlapped with each other, the DOF equal to or larger than 100 nm on the wafer could be ensured within in a region of 70 nm or more on the surface of the wafer. This example showed an excellent feature capable of optimizing exposure conditions for the peripheral portion and the central portion without an increase in the number of masks. FIG. 6 is a graph showing a wiring resistance distribution in this example. The abscissa indicates a resistance and the ordinate indicates a cumulative frequency.

### Example 2

The exposure process was performed by the same method as that of the second embodiment. In this example, different masks were used to expose the central portion and the peripheral portion based on the dipole condition described in Example 1. As shown in FIG. 7, a mask whose mask size is +4 nm larger than a design value was used for the central portion. A mask whose mask size is shifted by +8 nm was used for the peripheral portion. Here, for the simple explanation, the magnification of mask pattern against the corresponding pattern a wafer is again omitted.

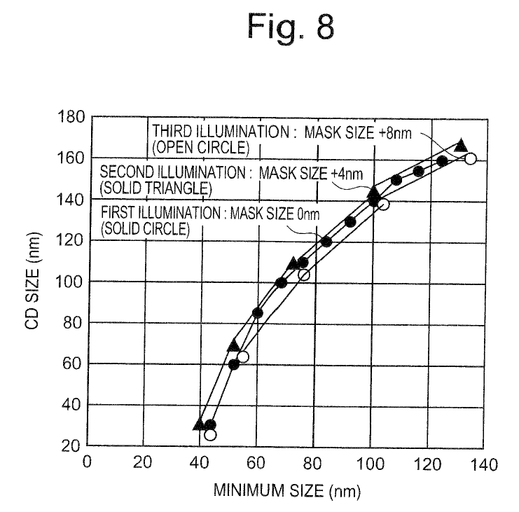

FIG. 8 shows a CD size of the central portion of the wafer and that of the edge portion thereof in the case where the mask size is shifted for the peripheral portion. According to this method, when the mask size is adjusted corresponding to each illumination system, while it is necessary to accurately correct a variation in size which is caused by the change of the illumination system, an excellent effect was obtained in which a variation in size in the peripheral portion does not occur unlike Example 1.

What is claimed is:

1. A method of a semiconductor device comprising;
exposing a first portion of a wafer with a first lens aperture, and
exposing a second portion of the wafer with a second lens aperture.

2. The method of manufacturing a semiconductor device according to claim 1, wherein the first portion is a central portion of the wafer; and the second portion is a peripheral portion around the central portion.

3. The method of manufacturing a semiconductor device according to claim 1, wherein:
the first lens aperture is for one of dipole illumination and annular illumination; and
the second lens aperture is for the other of the dipole illumination and the annular illumination.

4. The method of manufacturing a semiconductor device according to claim 1, wherein exposing the first portion and exposing the second portion use the same mask.

5. The method of manufacturing a semiconductor device according to claim 1, wherein exposing the second portion uses a plurality of illumination systems.

6. The method of manufacturing a semiconductor device according to claim 1, wherein:
exposing the first portion and exposing the second portion use masks having the same design and different mask sizes for one of an isolated line and an isolated hole;
the first lens aperture is for one of dipole illumination and annular illumination; and
the second lens aperture is for the other of the dipole illumination and the annular illumination.
